(19) United States
(12) Patent Application Publication
(10) Pub. No.: US 2015/0276373 A1
(43) Pub. Date: Oct. 1, 2015

(54) RESOLVER EXCITATION CIRCUIT

(71) Applicant: TOYOTA JIDOSHA KABUSHIKI KAISHA, Toyota-shi (JP)

(72) Inventors: Akihiko IDE, Okazaki-shi (JP); Makoto OISHI, Toyota-shi (JP)

(21) Appl. No.: 14/662,375

(22) Filed: Mar. 19, 2015

(30) Foreign Application Priority Data
Mar. 26, 2014 (JP) 2014-064644

(51) Int. Cl. G01B 7/30

(52) U.S. Cl. CPC G01B 7/30

(57) ABSTRACT

A resolver excitation circuit includes a D/A converter configured to generate a sinusoidal excitation signal being supplied to a resolver outputting a resolver signal to detect a rotation angle of a target object with a predetermined sampling frequency; and an amplifier configured to be constituted with an operational amplifier amplifying the excitation signal generated by the D/A converter. The operational amplifier has a gain-frequency characteristic set so that the predetermined sampling frequency is a higher frequency than a cutoff frequency of a gain of the operational amplifier, and the gain of the operational amplifier at the predetermined sampling frequency is lower than 0 dB.

### FIELD

The disclosures herein generally relate to a resolver excitation circuit that excites a resolver.

### BACKGROUND

Conventionally, a resolver excitation circuit that excites a resolver has been known (see, for example, Patent Document 1). A resolver excitation circuit described in Patent Document 1 includes a D/A (digital-analog) converter, an LPF (Low Pass Filter), and an amplifier.

The D/A converter converts digital data obtained by sampling a sinusoidal waveform into an analog signal with a predetermined sampling frequency, and generates a sinusoidal excitation signal that is supplied to the resolver to detect a rotation angle of a target object. The LPF is a circuit to remove high frequency components accompanying sampling (quantization) by the D/A converter from the sinusoidal excitation signal output from the D/A converter. The amplifier amplifies the sinusoidal excitation signal having the high frequency components removed, which is output from the LPF, to supply the amplified signal to the resolver.

Such a configuration of a resolver excitation circuit can prevent high frequency components accompanying quantization by the D/A converter from being amplified by the amplifier. Therefore, it possible to prevent an EMC (electromagnetic compatibility) performance from degrading, and to prevent the power consumption of the amplifier from increasing.

### RELATED-ART DOCUMENTS

### Patent Documents

[Patent Document 1] Japanese Laid-open Patent Publication No. 2004-309285

However, inclusion of the LPF in the resolver excitation circuit may result in an increase in cost because the number of circuit parts such as resistors and capacitors that constitute the LPF increases.

In view of the above, it is an object of at least one embodiment of the present invention to provide a resolver excitation circuit that can supply a desired excitation signal to a resolver without using an LPF.

### SUMMARY

According to at least one embodiment of the present invention, a resolver excitation circuit includes a D/A converter configured to generate a sinusoidal excitation signal being supplied to a resolver outputting a resolver signal to detect a rotation angle of a target object with a predetermined sampling frequency; and an amplifier configured to be constituted with an operational amplifier amplifying the excitation signal generated by the D/A converter. The operational amplifier has a gain-frequency characteristic set so that the predetermined sampling frequency is a higher frequency than a cutoff frequency of a gain of the operational amplifier, and the gain of the operational amplifier at the predetermined sampling frequency is lower than 0 dB.

According to at least one embodiment of the present invention, it is possible to supply a desired excitation signal to a resolver without using an LPF.

### BRIEF DESCRIPTION OF DRAWINGS

FIG. 1 is a configuration diagram of an angle detection apparatus including a resolver excitation circuit according to an embodiment of the present invention;

FIG. 2 is a circuit configuration diagram of an amplifier included in a resolver excitation circuit according to the embodiment; and

FIG. 3 is a diagram representing a gain-frequency characteristic of an amplifier included in a resolver excitation circuit according to the embodiment.

### DESCRIPTION OF EMBODIMENTS

In the following, specific embodiments of a resolver excitation circuit will be described according to the present invention with reference to the drawings.

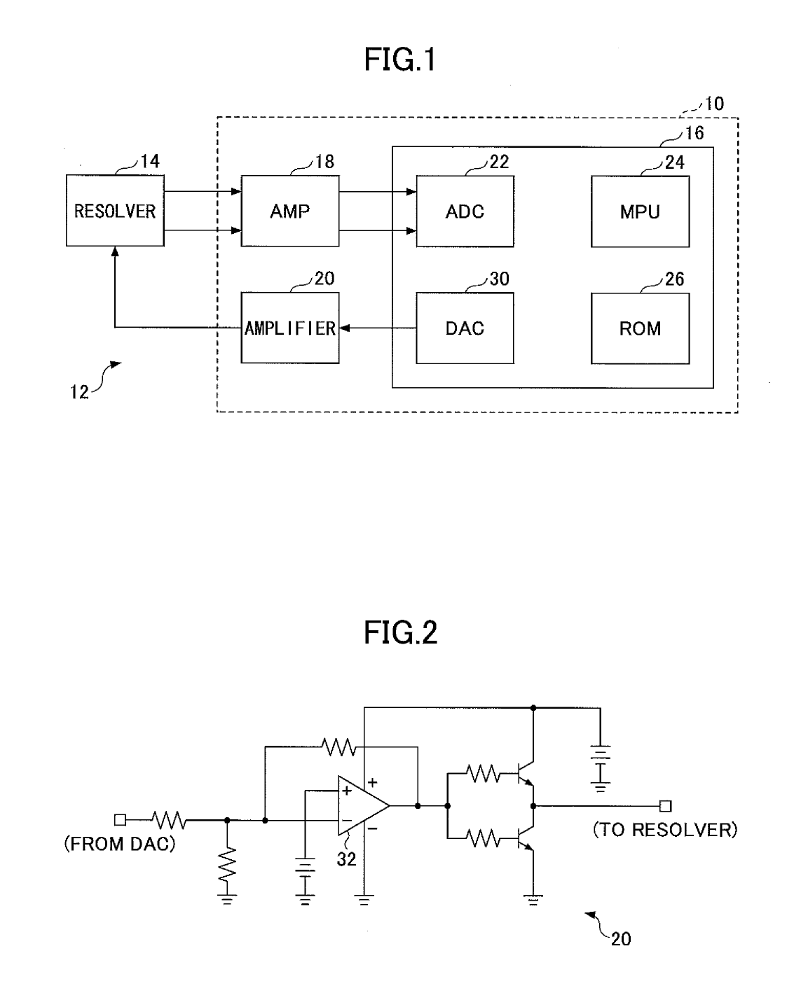

FIG. 1 illustrates a configuration diagram of an angle detection apparatus 12 including a resolver excitation circuit 10 according to an embodiment of the present invention. The angle detection apparatus 12 in the present embodiment is, for example, an apparatus that detects a rotation angle of a target object such as a motor built in a vehicle. The angle detection apparatus 12 includes a resolver 14 and a resolver excitation circuit 10 that excites the resolver 14.

The resolver 14 is a sensor that is disposed in the neighborhood of the rotational shaft of a motor, to output a resolver signal (analog signal) depending on a rotation angle of the rotational shaft. The resolver 14 outputs the resolver signal, which is an electric signal that changes by the amount of n cycles while the rotational shaft mechanically makes one rotation, namely, changes by the amount of an electrical angle of 360° while the rotational shaft mechanically rotates through a mechanical angle of 360° divided by n.

The resolver 14 includes one excitation coil and two detection coils. The excitation coil is a coil to which the resolver excitation circuit applies an excitation signal having a constant frequency fᵣ as will be described later. Also, the two detection coils are a sine coil and a cosine coil that extend in directions perpendicular to each other, and generate respective resolver signals depending on a rotation angle of the rotational shaft when the excitation signal is applied to the excitation coil to output the resolver signals to the resolver excitation circuit 10. One of the detection coils outputs a sinusoidal signal whose amplitude changes sinusoidally depending on the rotation angle of the rotational shaft, and the other detection coil outputs a cosinusoidal signal whose amplitude changes cosinusoidally depending on the rotation angle of the rotational shaft. The signals output by the respective detection coils have phases shifted from each other by an electrical angle of 90°. The resolver 14 outputs, as the resolver signals, the sinusoidal signal and cosinusoidal signal depending on the rotation angle of the rotational shaft.

The resolver excitation circuit 10 is an electronic control unit (ECU) mainly configured with a microcomputer 16. The resolver excitation circuit 10 includes an amplifier 18, the microcomputer 16, and an amplifier 20. The outputs of the resolver 14 (or two detection coils) are connected with the inputs of the amplifier 18. The sinusoidal signal and cosinusoidal signal output by the resolver 14 are input into the amplifier 18. The amplifier 18 amplifies the sinusoidal signal and cosinusoidal signal from the resolver 14 to have a predetermined voltage range.

The outputs of the amplifier 18 are connected with inputs of the microcomputer 16. The amplified sinusoidal signal and cosinusoidal signal output by the amplifier 18 are input into the microcomputer 16. The microcomputer 16 includes an A/D converter 22, an MPU (Micro Processing Unit) 24, a ROM 26, and a D/A converter 30. The A/D converter 22, the MPU 24, the ROM 26, and the D/A converter 30 are connected with each other via a bus.

The A/D converter 22 has a predetermined resolution, and applies analog-digital conversion (A/D conversion) to the sinusoidal signal and cosinusoidal signal from the amplifier 18 by sampling with a predetermined sampling frequency f_{AD}. Various maps and programs are stored in the ROM 26. Also, digital data obtained by sampling the sinusoidal waveform with the predetermined sampling frequency f_{DA} is stored in the ROM 26.

The D/A converter 30 applies digital-analog conversion (D/A conversion) to the digital data read out from the ROM 26 by DMA (Direct Memory Access) to convert the digital data into an analog signal with the predetermined sampling frequency f_{DA}. Namely, the D/A converter 30 generates an excitation signal from the digital data read out from the ROM with the predetermined sampling frequency f_{DA}, which is supplied to the resolver 14. By applying the D/A conversion, the time waveform of the excitation signal supplied to the resolver 14 becomes a sinusoidal waveform.

Also, the output of the D/A converter 30 of the microcomputer 16 is connected with the input of the amplifier 20. The sinusoidal excitation signal output by the D/A converter 30 is input into the amplifier 20. The amplifier 20 amplifies the sinusoidal excitation signal from the D/A converter 30. The output of the amplifier 20 is connected with the input of the resolver 14 (namely, the excitation coil). The amplified sinusoidal excitation signal output by the amplifier 20 is input into the resolver 14. The resolver 14 outputs the resolver signals depending on the rotation angle of the rotational shaft in a state where it is excited by the excitation signal from the resolver excitation circuit 10.

The MPU 24 of the microcomputer 16 executes various controls based on maps, programs, and various data stored in the ROM 26. Specifically, to supply the excitation signal having a desired excitation frequency (for example, 10 kHz) fᵣ from the D/A converter 30 to the resolver 14, the MPU 24 supplies digital data (sinusoidal data) to the D/A converter 30, for example, at a rate of 20 samples per cycle. Then, the MPU 24 makes the D/A converter 30 execute D/A conversion with a predetermined sampling frequency (for example, 200 kHz) f_{DA}. Also, the MPU 24 makes the A/D converter 22 execute A/D conversion with a predetermined sampling frequency (for example, 10 kHz) f_{AD}.

The MPU 24 synchronizes a timing when the A/D converter 22 applies A/D conversion to the sinusoidal signal and cosinusoidal signal from the amplifier 18, with a timing when the D/A converter 30 applies D/A conversion to the digital data from the A/D converter 22. Synchronizing in this way, the A/D conversion can be applied to the sinusoidal signal and cosinusoidal signal output from the resolver 14 at a specific phase of the sinusoidal excitation signal (specifically, a positive peak and a negative peak of the excitation signal).

Therefore, in the present embodiment, an influence of the excitation signal that excites the resolver 14 can be excluded from the digital data having the A/D conversion applied by the A/D converter 22 so that the digital data having the A/D conversion applied only depends of the rotation angle of the rotational shaft. Based on the digital data having the A/D conversion applied by the A/D converter 22, the MPU 24 detects the rotation angle of the rotational shaft, and externally outputs an encode signal representing the detected rotation angle.

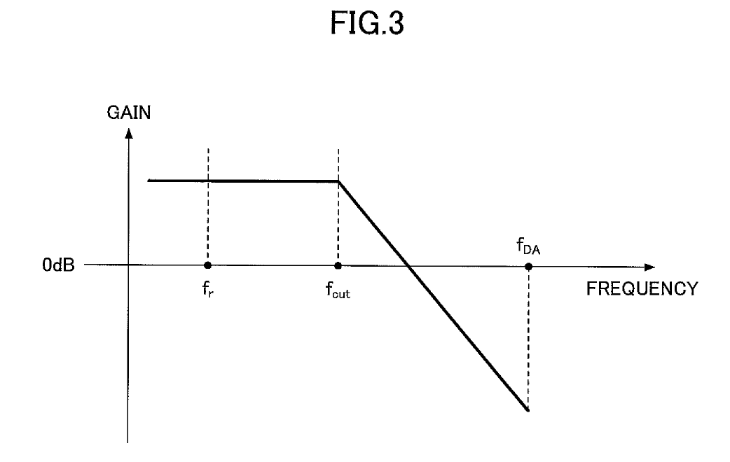

FIG. 2 illustrates a circuit configuration diagram of the amplifier 20 included in the resolver excitation circuit 10 according to the present embodiment. Also, FIG. 3 illustrates a diagram that represents a gain-frequency characteristic of the amplifier 20 included in the resolver excitation circuit 10 according to the present embodiment.

In the present embodiment, the resolver excitation circuit 10 includes the amplifier 20 that amplifies the sinusoidal excitation signal output from the D/A converter 30, and outputs the amplified signal to the resolver 14. The amplifier 20 is configured with an operational amplifier 32. This operational amplifier 32 has a predetermined gain (voltage gain)-frequency characteristic. The operational amplifier 32 amplifies the sinusoidal excitation signal from the D/A converter 30 while removing high frequency components.

Specifically, as shown in FIG. 3, the cutoff frequency f_{cut} of the gain of the operational amplifier 32 is higher than the excitation frequency fᵣ of the excitation signal output from the D/A converter 30 to the resolver 14, and lower than the sampling frequency f_{DA} of the D/A converter 30. Also, the gain of the operational amplifier 32 at the sampling frequency f_{DA} of the D/A converter 30 is lower than 0 dB (dB). Namely, the gain-frequency characteristic of the operational amplifier 32 is set so that the sampling frequency f_{DA} of the D/A converter 30 is a higher frequency than the cutoff frequency f_{cut} of the gain of the operational amplifier 32, and the gain of the operational amplifier 32 at the sampling frequency f_{DA} is lower than 0 dB.

By setting the sampling frequency f_{DA} of the D/A converter 30 at a higher frequency than the cutoff frequency f_{cut} of the gain of the operational amplifier 32, and setting the gain of the operational amplifier 32 at the sampling frequency f_{DA} to be lower than 0 dB, high frequency components accompanying sampling by the D/A converter 30 included in the excitation signal output from the D/A converter 30 to the resolver 14 are attenuated following the gain-frequency characteristic of the operational amplifier 32, and the high frequency components included in the excitation signal are securely suppressed in the operational amplifier 32.

Therefore, according to the resolver excitation circuit 10 in the present embodiment, the waveform of the excitation signal supplied to the resolver 14 can be made only including the desired excitation frequency fᵣ while removing the high frequency components accompanying sampling by the D/A converter 30. Therefore, according to the present embodiment, it possible to prevent EMC (electromagnetic compatibility) performance from degrading, and to prevent the power consumption of the amplifier from increasing, which could be caused if the high frequency components were amplified.

Also, in the present embodiment, to remove the high frequency components accompanying sampling by the D/A converter 30 from the excitation signal, an LPF does not need to be disposed between the D/A converter 30 and the resolver 14 that is constituted with circuit parts such as resistors and capacitors, and it is sufficient to have the operational amplifier 32, which is included in the amplifier 20 disposed between the D/A converter 30 and the resolver 14, provided with a function to remove the high frequency components. In this regard, according to the resolver excitation circuit 10 in the present embodiment, an excitation signal having a desired excitation frequency fᵣ can be supplied to the resolver 14 without using an LPF constituted with resistors and capacitors. Therefore, according to the present embodiment, when exciting the resolver 14, it is possible to prevent the number of circuit parts and the cost from increasing, which would be inevitable if an LPF were disposed.

Incidentally, the resolver 14 in the above embodiment is a single-phase-excitation, two-phase-output resolver. However, the present invention is not limited to that, but it may be a two-phase-excitation, single-phase-output resolver, or a two-phase-excitation, two-phase-output resolver.

The present application is based on Japanese Priority Application No. 2014-064644, filed on Mar. 26, 2014, the entire contents of which are hereby incorporated by reference.

What is claimed is:

1. A resolver excitation circuit comprising:
a D/A converter configured to generate a sinusoidal excitation signal being supplied to a resolver outputting a resolver signal to detect a rotation angle of a target object with a predetermined sampling frequency; and
an amplifier configured to be constituted with an operational amplifier amplifying the excitation signal generated by the D/A converter,
wherein the operational amplifier has a gain-frequency characteristic set so that the predetermined sampling frequency is a higher frequency than a cutoff frequency of a gain of the operational amplifier, and the gain of the operational amplifier at the predetermined sampling frequency is lower than 0 dB.
